(19) United States
(12) Patent Application Publication
(10) Pub. No.: US 2006/0166558 A1
(43) Pub. Date: Jul. 27, 2006

(54) Shield connector

(76) Inventor: Yoshikazu Katoh, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 11/335,688

(22) Filed: Jan. 20, 2006

(30) Foreign Application Priority Data
Jan. 24, 2005 (JP) 2005-015398

(51) Int. Cl. H01R 9/03

(52) U.S. Cl. 439/610

(57) ABSTRACT

To decrease a space necessary for a layout for mounting an inner shell contained in a shield connector, a shield connector has an upper inner shell and a lower inner shell for electric shield of a cable in the shield connector, wherein a structure for latching operation of respective sidewalls of the upper inner shell and the lower inner shell, the sidewalls being vertically opposed to each other, is configured by a protrusion formed within sheet thickness of one sidewall, and a fitting-in portion which is formed within sheet thickness the other sidewall and formed in such a shape that the protrusion is fitted therein.

### BACKGROUND OF THE INVENTION

1. Field of the Invention

The present invention relates to a shield connector.

2. Related Art

For example, as shown in FIG. 4A to FIG. 5B, a connector 10 with shield has metallic, inner shells 11, 12 for electrically shielding a cable including a plurality of bundle wires to be connected to a contact. A connector housing 13 that acts as a synthetic resin chassis covers over the outsides of the inner shells 11, 12.

The inner shells 11, 12 are opened at the front, dosed at the back with a space for a diameter of the cable being secured, and dosed at sides by sidewalls 11a, 12a being overlapped with each other, so that the cable is electrically shielded. Known inner shells are configured in such a way that the sidewalls 11a, 12a are overlapped with each other as shown in FIG. 5A and FIG. 5B so that they are not pulled out from each other by using a hole 12b provided in a part of the sidewall and a protrusion for latching 11b (refer to JP-A-2004-63273).

However, in the connector with shield 10 in the related art, as shown in FIG. 5B, since the sidewalls 11a and 12a are horizontally overlapped with each other, the total thickness of the shells is equal to t×4 (+clearance), wherein t is sheet thickness of a sidewall, in the right and left direction, consequently a design margin is lost in a current situation where significant size reduction and increase in packaging density are advanced. If the thickness based on the sheet thickness of the inner shells can be decreased as much as possible, the design margin can be created.

### SUMMARY OF THE INVENTION

Thus, the shield connector according to the invention was proposed to solve such a problem.

To solve the problem, a shield connector according to the invention has an upper inner shell and a lower inner shell for electric shield of a cable in the shield connector, wherein a structure for latching operation of respective sidewalls of the upper inner shell and the lower inner shell, the sidewalls being vertically opposed to each other, is configured by a protrusion formed within sheet thickness of one sidewall, and a fitting-in portion which is formed within sheet thickness of the other sidewall and formed in such a shape that the protrusion is fitted therein.

A protrusion protruded from a plane of sheet thickness of the sidewall to the inside of the inner shell is preferably provided on a part of the protrusion or a part where the fitting-in portion is formed.

Moreover, the protrusion and the fitting-in portion are preferably formed into an approximate T shape or an approximate L shape in a side view.

According to the shield connector of the invention, when a vertical latching condition is realized by the upper and lower inner shells, the condition is realized within a range of sheet thickness corresponding to a thickness of a sidewall in each of the right and left, two sidewalls. Accordingly, in design of determining a layout of components of the shield connector, a margin corresponding to the sheet thickness of the inner shell is created in the right and left direction, and consequently the degree of freedom in design is increased.

Moreover, the protrusion protruded from the plane of the sheet thickness of the sidewall to the inside of the inner shell is provided on the part of the protrusion or the part where the fitting-in portion is formed, thereby the latching operation is ensured.

Furthermore, since the protrusion and the fitting-in portion are formed in the approximate T shape or the approximate L shape in the side view, they are easily configured.

### BRIEF DESCRIPTION OF THE DRAWING

FIG. 1A is a plan view of a shield connector according to the invention, showing a part of the connector in a cross section view;

FIG. 1B is a front view showing a condition where inner shells are mounted in a connector housing;

FIG. 2A is an exploded perspective view showing relevant parts of an upper inner shell and a lower inner shell in the shield connector;

FIG. 2B is a partially perspective view showing a condition where the upper inner shell and the lower inner shell are combined;

FIG. 3A is a front view showing a front end of the upper inner shell;

FIG. 3B is a plan view showing a relevant part of the lower inner shell;

FIG. 3C is a side view showing the relevant part of the lower inner shell;

FIG. 4A is a plan view showing a connector with shield according to the prior art in a partial cross section;

FIG. 4B is a front view showing the connector with shield according to the prior art in a partial cross section;

FIG. 5A is an exploded perspective view showing relevant parts of inner shells of the connector with shield of FIG. 4A and FIG. 4B; and

FIG. 5B is a longitudinal section view showing a condition of overlapping of the sidewalls and a condition of latching operation when the inner shells are combined in the connector with shield of FIG. 5A.

### DETAILED DESCRIPTION OF PREFERRED EMBODIMENT

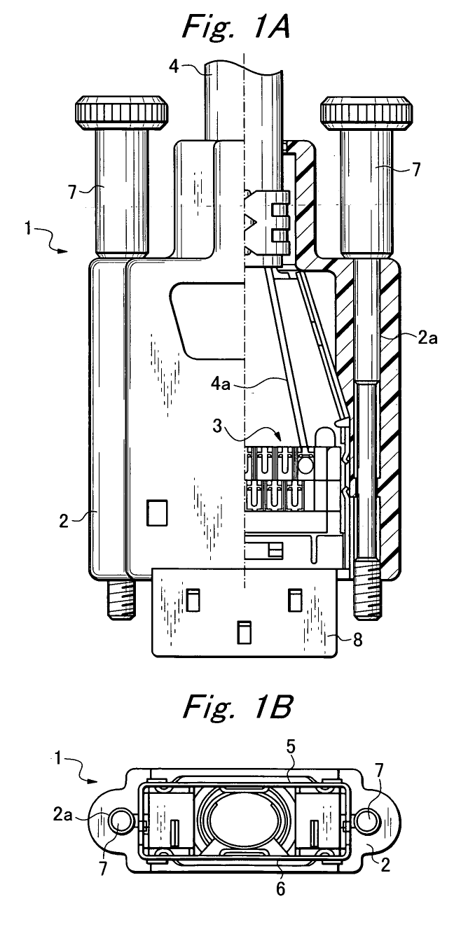

As shown in FIGS. 1A and 1B, the shield connector 1 according to the invention has an approximately rectangular connector housing 2 in the inside of which a plurality of contacts 3 arranged horizontally, lead wires 4a connected to the contacts 3, an end of a cable 4 formed by bundling the lead wires, and an upper inner shell 5 and a lower inner shell 6 for an electric shield operation are provided. Moreover, through-holes 2a exist in horizontal, two sides of the connector housing 2, the through-holes being run through in a back and forth direction, and locking screws 7 for connection locking are mounted therein. A contact shell 8 that encloses a connection opening for electrical shield is provided at front ends of the inner shells 5 and 6.

A pitch between the locking screws 7, 7 is determined by a pitch of female screws in an opposite connector to be connected. Moreover, the plurality of contacts 3 needs to be arranged. Accordingly, since the inner shells 5, 6 are mounted with being arranged between the screws and the contacts, there is only a gap in a level corresponding to about a sheet thickness (t=0.3 mm) of the inner shell in the horizontal direction in view of clearance.

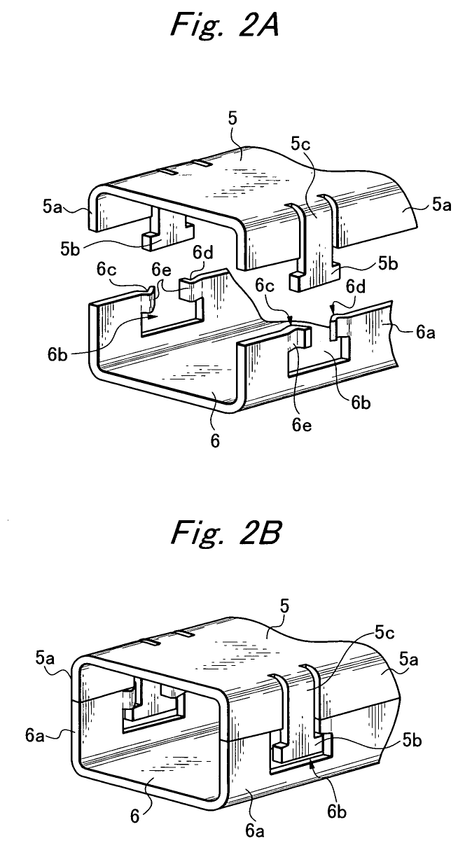

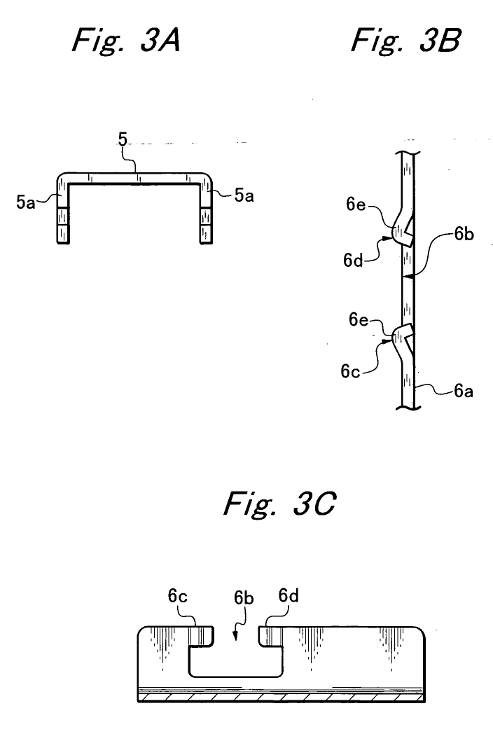

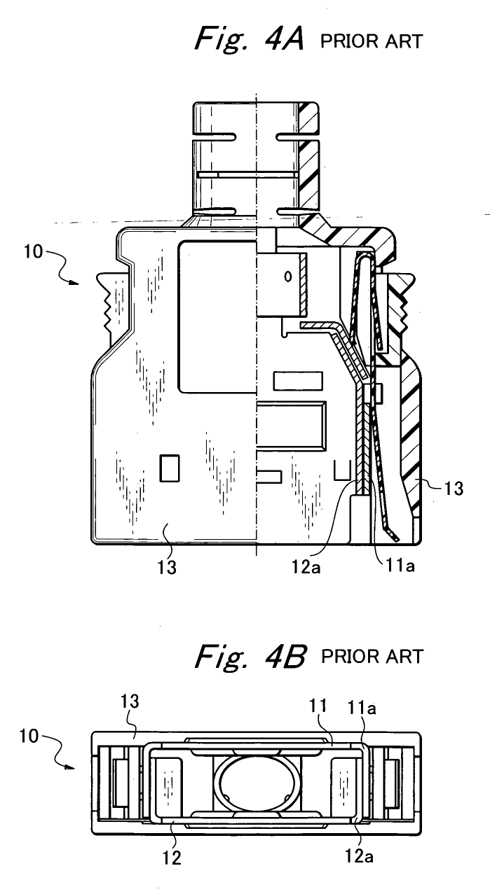

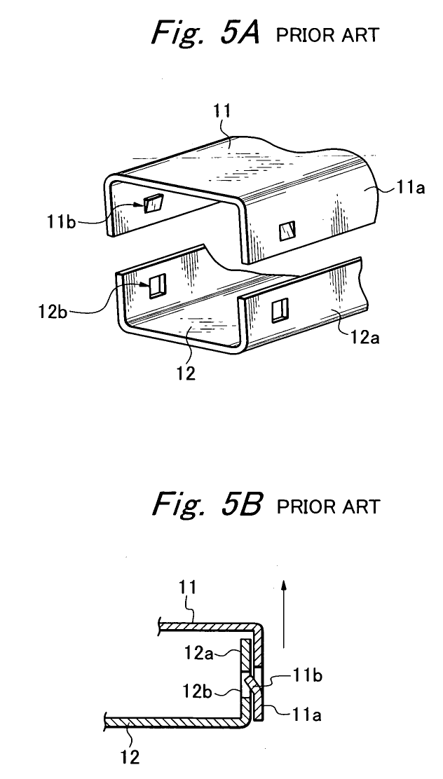

Thus, as shown in FIG. 2A to FIG. 3A, parts of the inner shells 5 and 6 are formed into protrusions and fitting-in portions which are relevant parts of the invention. That is, as an embodiment, a T-shaped protrusion 5b is formed within a sheet thickness of the sidewall 5a (for example, t=0.3 mm) in a sidewall 5a of the upper inner shell 5.

The protrusion 5b is supported by an elastic support strip 5c formed by providing slits at both sides approximately from about a base of the sidewall 5a.

As a fitting-in portion 6b, as shown in FIGS. 2A, 2B and FIGS. 3B, 3C, in a sidewall 6a of the lower inner shell 6, a T-shaped punching portion is formed within thickness of the sidewall 6a such that the protrusion 5b can be fitted laterally in the portion. While the fitting-in portion 6b is formed as an opening by horizontally punching the sidewall because thickness of the upper and lower inner shells 5, 6 are the same in the shown embodiment, if the thickness of the protrusion 5b is smaller than the thickness of the sidewall at a fitting-in side, the fitting-in portion 6b can be formed as a recess that is depressed using a T-shaped die from the inside or the outside.

Latching strips 6c, 6d, which are parts for forming the fitting-in portion 6b, have protrusions 6e protruded from a plane of sheet thickness of the sidewall 6a to the inside of the inner shell. Thus, when a space in which an electronic component can be mounted exists in a part of the inside of the inner shell, such protrusions 6e can be formed, consequently the T-shaped protrusion 5b can be securely prevented from being pulled out upward.

While the protrusion 5b and the fitting-in portion 6b are formed in an approximate T shape, they may be formed in an L-shape without being limited to this.

In this way, the upper inner shell 5 and the lower inner shell 6 are formed, and they are combined with end faces of the sidewalls being vertically butted each other as shown in FIG. 2B, and then mounted within the connector housing 2, thereby as shown in FIG. 1B, a structure for latching operation for preventing the inner shells from being vertically pulled out can be received within the sheet thickness of the sidewall 5a or 6a of the inner shells. Accordingly, in the prior art, since sidewalls of the upper and lower shells were horizontally overlapped with each other, the space corresponding to t×4, wherein “t” was the sheet thickness of the sidewall, was necessary for the shells, however, in the invention, the space is decreased to t×2 in which “t” is the sheet thickness, or a half. In this way, in the invention, the space is increased by a space corresponding to twice the sheet thickness “t” of the shell in design of a layout for mounting components in the right and left direction of the shield connector 1, consequently the degree of freedom in design is increased.

1. A shield connector having an upper inner shell and a lower inner shell for electric shield of a cable in the shield connector, wherein
a structure for latching operation of respective sidewalls of the upper inner shell and the lower inner shell, the sidewalls being vertically opposed to each other, is configured by a protrusion formed within sheet thickness of one sidewall, and a fitting-in portion which is formed within sheet thickness of the other sidewall and formed in such a shape that the protrusion is fitted therein.

2. A shield connector according to claim 1, wherein
a protrusion protruded from a plane of sheet thickness of the sidewall to the inside of the inner shell is provided on a part of the protrusion or a part where the fitting-in portion is formed.

3. A shield connector according to claim 1, wherein the protrusion and the fitting-in portion are formed into an approximate T shape or an approximate L shape in a side view.

4. A shield connector according to claim 2, wherein
the protrusion and the fitting-in portion are formed into an approximate T shape or an approximate L shape in a side view.
